(19) United States
(12) Patent Application Publication
(10) Pub. No.: US 2006/0182850 A1
(43) Pub. Date: Aug. 17, 2006

(54) Composition of film envelope for growing clean agricultural products, method for fabricating the same, and cultivation method for clean agricultural products

(76) Inventors: Kyung-Sub Lee, Seoul (KR); Hyun-Seon Hong, Kyungki-do (KR); Min-Uk Kim, Busan (KR); Seung-Ryong Lee, Seoul (KR)

Correspondence Address: PERKINS COIE LLP, P.O. BOX 2168, MENLO PARK, CA, 94026, US

(21) Appl. No.: 10/547,225

(22) PCT Filed: Feb. 6, 2004
(86) PCT No.: PCT/KR04/02234

§ 371 Date: Aug. 26, 2005

(30) Foreign Application Priority Data
Sep. 5, 2003 (KR) 10-2003-0062280

(51) Int. Cl. A23B 7/148

(52) U.S. Cl. 426/106

(57) ABSTRACT

Disclosed are a synthetic resin film envelope and a cultivating method for clean agricultural products. The synthetic resin film envelope is formed with a double-layer sectional structure having a thickness of about 0.02 to 0.1 mm and includes 60 to 90 weight percent of polypropylene resin having a melt index of 3 to 10 g/min at a temperature of 185° C., 1 to 20 weight percent of an antifogging agent, 1 to 10 weight percent of an antistatic agent, and 1 to 10 weight percent of white carbon.

### TECHNICAL FIELD

The present invention relates to a composition of a film envelope for growing clean agricultural products, and a cultivation method for clean agricultural products, and more particularly to a composition of a synthetic resin film envelope for growing clean agricultural products having a double layer structure with a thickness of about 0.01 to 0.1 mm and including 60 to 90 weight percent of polypropylene resin having a melt index of 3 to 10 g/min at a temperature of 185° C., 1 to 20 weight percent of an antifogging agent, 1 to 10 weight percent of an antistatic agent and 1 to 10 weight percent of white carbon, and a method for fabricating the same.

In the present invention, clean agricultural products include cucumbers, pears, grapes, watermelons, strawberries, oranges, bananas, eggplants, red peppers, and pumpkins.

The present invention relates to a co-extruded film for cultivating clean agricultural products. The co-extruded film is an antifogging cast polypropylene film including a surface active agent having an antifogging property. The present invention provides a synthetic resin film envelope representing a superior dew condensation proof characteristic at an inner portion thereof, so that agricultural products contained in the synthetic resin film envelope maintain a high degree of freshness.

### BACKGROUND ART

Generally, agricultural products including cucumbers are cultivated by using a large amount of pesticides. However, consumers are reluctant to have the agricultural products cultivated with a large amount of agricultural medicines. That is, consumers prefer to have clean agricultural products. Hereinafter, the present invention will be described in relation to a cucumber as an example of agricultural products.

According to the present invention, when a cucumber has a length of 10 cm and flowers thereof have gone, the cucumber is wrapped with a synthetic resin film envelope so as to prevent agricultural medicines from sticking to the cucumber, thereby cultivating a clean cucumber.

The synthetic resin film envelope of the present invention encloses the cucumber while the cucumber is being grown in order to allow the cucumber to be grown in a straight shape with uniform thickness and length. Generally, a cucumber is slightly bent while the cucumber is being grown. However, the commercial value and marketability of the cucumber may increase if the cucumber has a straight shape with uniform thickness and length. The present invention is provided to grow the cucumber such that the cucumber has a straight shape with uniform thickness and length. According to the present invention, the cucumber is linearly grown at an inner space section of a transparent synthetic resin envelope film by enclosing the cucumber using the transparent synthetic resin envelope film. The synthetic resin envelope film has a width of about 4 to 6 cm and a length of about 27 to 29 cm so as to allow the cucumber to be grown in a straight shape with uniform thickness and length. The cucumber has a superior commercial value when the cucumber has the above size. According to the present invention, the synthetic resin envelope film enclosing the cucumber is opened when the cucumber has been grown corresponding to the above size so that a user can effectively harvest the cucumbers. In addition, the film envelope of the present invention is made from transparent synthetic resin having a lightweight so that light is easily incident into the cucumber.

Since the clean agricultural products including the cucumber are organic substances, the clean agricultural products generate water after the clean agricultural products have been wrapped with the synthetic film envelope. Thus, when the cucumber is wrapped with a conventional film envelope, small waterdrops are formed at a surface of the conventional film envelope due to water generated from the cucumber. Accordingly, the conventional film envelope is hazy with steam so that an external appearance of the conventional film envelope becomes deteriorated and freshness of the cucumber becomes reduced, causing degradation of the cucumber.

In addition, since a conventional antifogging film is rarely torn, if clean agricultural products including cucumbers are wrapped with an envelope made from the conventional antifogging film, it is necessary to cut the conventional antifogging film envelope with a knife. In addition, when the clean agricultural products including cucumbers are wrapped with a conventional synthetic resin film, the surface of the conventional synthetic resin film becomes hazy due to a dew condensation phenomenon caused by water generated from the clean agricultural products, so the clean agricultural products cannot be easily grown. In addition, the clean agricultural products including cucumbers may be subject to illness such as “black rot”.

Generally, an agricultural synthetic resin film used in forcing culture or late raising for props in an agricultural house or a vinyl tunnel includes polyvinyl chloride, polyethylene, and ethylene-acetic acid vinyl copolymer resin. Such an agricultural synthetic resin film has a hydrophobic property so that water generated from a ground or props are condensed on the film surface, thereby forming small waterdrops on the film surface. The agricultural synthetic resin film may be hazy with steam due to the waterdrops so that an amount of light incident into the props may be reduced. Thus, the props cannot be easily grown and may be subject to illness such as “black rot” due to waterdrops falling onto the props. In order to solve the above problems, a surface active agent, such as sorbitan fatty acid ester called an “antifogging agent”, is roll-mixed with synthetic resin when forming synthetic resin articles. In this case, a surface of the synthetic film is easily wetted due to “breed out” of the antifogging agent. Alternatively, the antifogging agent is coated on the surface of the synthetic film after forming the synthetic film. The former (roll mixing type method) is adaptable for a short-term use of about 1 to 2 years, and the latter (coating type method) is adaptable for a long-term use of more than 2 years. According to the coating type method, it is necessary to spray the antifogging agent on a surface of an agricultural film after forming the agricultural film. When spraying the antifogging agent on the surface of the agricultural film, a large amount of coating agents is wasted, so the coating type method represents an economical efficiency inferior to that of the roll mixing type method. In addition, the coating type method requires a long period of working time and forms a stain on the surface of the agricultural film, thereby lowering an antifogging effect. In contrast, according to the roll mixing type method, the antifogging agent is added to a raw material of a synthetic resin film during the fabrication of the film so that it is unnecessary to perform coating work with respect to the synthetic resin film in situ. Thus, the synthetic resin film having an antifogging property can be easily and simply fabricated and used.

The antifogging agents used for the roll-mixing type method include polyvalent alcohol ester, such as sorbitan, glycerin and long chain fatty acid including stearic acid (see, Japanese Patent Publication No. 59-35573), and polyvalent alcohol long chain fatty acid ester, such as sorbitan long chain fatty acid ester (see, Japanese Patent Publication No. 38-6572) and oxide ethylene additives thereof (see, Japanese Patent Publication No. 55-9431), glycerin fatty acid ester (see, Japanese Patent Publication No. 38-4174), and polyglycerin fatty acid ester (see, Japanese Patent Publication No. 43-8605). However, the above antifogging agents represent an inferior antifogging property at a low-temperature and an initial antifogging property thereof cannot be continuously maintained. That is, the antifogging property of the above antifogging agents becomes deteriorated when they are used in a region having a great temperature difference between morning and afternoon or in a region having a low temperature. In order to solve the above problem, polyoxyethylenealkylamine (see, Japanese Patent Publication No. 44-15184), long chain fatty acid ester thereof (see, Japanese Patent Publication No. 62-33256), and a mixture of the above components and polyvalent alcohol fatty acid ester have been suggested as an antifogging agent. Such an antifogging agent may ensure a superior antifogging property for a long period of time, but may cause a blooming phenomenon at a surface of a film so that the transparent property of the film is significantly deteriorated. Thus, the above antifogging agent cannot be used in practice. In order to ensure the superior antifogging property for a long period of time while preventing the film from becoming opaque, there has been suggested a method for mixing an antifogging agent with at least one selected from the group consisting of bis (polyethoxy) alkylamine-based ester, which is long chain fatty acid, linear or branched fatty acid having 12 to 60 carbon atoms, and hydroxy fatty acid (see, Japanese Patent Laid-Open Publication No. 2000-7828). However, an effect thereof is not yet verified. In addition, Japanese Patent Laid-Open Publication No. 11-335486 discloses a composition ensuring an initial antifogging property for a long period of time. The above composition is obtained by mixing one selected from the group consisting of fatty acid ester (sorbitol)•ethylene oxide (EO) additives and fatty acid ester of EO additives of polyvalent alcohol with one selected from the group consisting of pentaerythritol fatty acid ester, additives of propylene oxide (PO) such as sorbitan, and sorbitan fatty acid polyvalent ester. However, Japanese Patent Publication No. 11-335486 does not disclose a method for ensuring a low temperature antifogging property. In addition, Japanese Patent Laid-Open Publication No. 10-310706 discloses long chain fatty acid ester including montan wax as an anti-dew agent. In addition, a fluorine-based surface active agent is used as an antifogging agent. The anti-dew agent and the antifogging agent are mixed with resin so that it is possible to achieve an agricultural synthetic resin film capable of maintaining an antifogging property for a long period of time. However, Japanese Patent Laid-Open Publication No. 10-310706 does not disclose an effect represented when the anti-dew agent is only used. In addition, Japanese Patent Laid-Open Publication No. 10-310706 does not disclose a method of maintaining an initial antifogging effect for a long period of time and an antifogging effect at a low temperature.

### DISCLOSURE OF THE INVENTION

Therefore, the present invention has been made in view of the above-mentioned problems, and it is an object of the present invention to provide a synthetic resin film capable of preventing a dew condensation phenomenon at an inner surface of a film envelope, improving an external appearance of an article made from the synthetic film, and representing a superior thermal adhesive property at a lower temperature. The above object can be accomplished by providing a cast polypropylene film for clean agricultural products having antifogging and thermal adhesive properties, in which an antifogging surface active agent is mixed with polypropylene resin and the mixture is extruded through a co-extrusion technique.

In order to accomplish the above object, according to a first aspect of the present invention, there is provided a synthetic resin film envelope for clean agricultural products, the synthetic resin film envelope comprising 60 to 90 weight percent of synthetic resin having a melt index of 3 to 10 g/min at a temperature of 185° C., 1 to 20 weight percent of an antifogging agent, 1 to 10 weight percent of an antistatic agent, and 1 to 10 weight percent of white carbon, wherein the synthetic resin envelope has a thickness of about 0.01 to 0.1 mm with a double-layer sectional structure.

According to the preferred embodiment of the present invention, the synthetic resin includes at least one selected from the group consisting of polyethylene resin, polypropylene resin, polypropylene copolymer resin, polyvinyl chloride resin, and ethylene-acetic acid vinyl copolymer resin. The clean agricultural products include cucumbers, pears, grapes, watermelons, strawberries, oranges, bananas, eggplants, red peppers, and pumpkins. The antifogging agent includes at least one selected from the group consisting of sorbitan fatty acid ester, glycerin fatty acid ester, and polyglycerin fatty acid ester.

If the clean agricultural products are cucumbers, the synthetic resin film envelope is preferably formed with a double-layer sectional structure having a width of about 4 to 6 cm and a length of about 27 to 29 cm. Alternatively, if the clean agricultural products are cucumbers, the synthetic resin film envelope can be formed with a double-layer sectional structure having a thickness of about 0.07 mm, a width of about 4 to 6 cm and a length of about 27 to 29 cm.

In order to accomplish the above object, according to a second aspect of the present invention, there is provided a method of fabricating a synthetic resin film envelope for clean agricultural products, the method comprising the steps of: preparing a mixture including 60 to 90 weight percent of synthetic resin having a melt index of 3 to 10 g/min at a temperature of 185° C., 1 to 20 weight percent of an antifogging agent, 1 to 10 weight percent of an antistatic agent, and 1 to 10 weight percent of white carbon; inputting the mixture into an inflation film extruder through a hopper so as to obtain a roll-film having a double-layer sectional structure with a thickness of about 0.01 to 0.1 mm.

According to the preferred embodiment of the present invention, the synthetic resin includes at least one selected from the group consisting of polyethylene resin, polypropylene resin, polypropylene copolymer resin, polyvinyl chloride resin, and ethylene-acetic acid vinyl copolymer resin. If the clean agricultural products are cucumbers, the synthetic resin film envelope can be formed with a double-layer sectional structure having a thickness of about 0.07 mm, a width of about 4 to 6 cm and a length of about 27 to 29 cm.

In order to accomplish the above object, according to a third aspect of the present invention, there is provided a method of growing clean agricultural products, the method comprising the steps of: preparing a synthetic resin film envelope including 60 to 90 weight percent of polypropylene resin having a melt index of 3 to 10 g/min at a temperature of 185° C., 1 to 20 weight percent of an antifogging agent, 1 to 10 weight percent of an antistatic agent, and 1 to 10 weight percent of white carbon; installing a fixing pin at an upper end of the synthetic resin film envelope; wrapping immature clean agricultural products with the synthetic resin film envelope when the immature clean agricultural products have lengths of about 5 to 10 cmm and flowers thereof have gone; and harvesting clean agricultural products after a predetermined period of time lapses after wrapping immature clean agricultural products with the synthetic resin film envelope. According to the preferred embodiment of the present invention, the synthetic resin includes at least one selected from the group consisting of polyethylene resin, polypropylene resin, polypropylene copolymer resin, polyvinyl chloride resin, and ethylene-acetic acid vinyl copolymer resin.

In order to accomplish the above object, according to a fourth aspect of the present invention, there is provided a method of growing clean cucumbers, the method comprising the steps of: preparing a synthetic resin film envelope having a thickness of about 0.01 to 0.1 mm, a width of about 4 to 6 cm, and a length of about 27 to 29 cm, and including 60 to 90 weight percent of polypropylene resin having a melt index of 3 to 10 g/min at a temperature of 185° C., 1 to 20 weight percent of an antifogging agent, 1 to 10 weight percent of an antistatic agent, and 1 to 10 weight percent of white carbon; installing a fixing pin at an upper end of the synthetic resin film envelope; wrapping immature clean cucumbers with the synthetic resin film envelope when the immature cucumbers have lengths of about 5 to 10 cmm and flowers thereof have gone; and harvesting clean cucumbers having lengths of about 24 to 27 cm when 5 to 8 days lapse after wrapping the immature clean cucumbers with the synthetic resin film envelope. According to the preferred embodiment of the present invention, the synthetic resin film envelope is formed with a double-layer sectional structure having a thickness of about 0.07 mm, a width of about 4.9 cm, and a length of about 29, and includes 84 weight percent of polypropylene resin having a melt index of 3 to 10 g/min at a temperature of 185° C., 6 weight percent of sorbitan fatty acid ester, 5 weight percent of an antistatic agent, and 5 weight percent of white carbon.

Synthetic resin used for the present invention includes IPP, CPP or OPP available from Dae-Young Synthetic Resin Industrial Company of Korea.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view illustrating a co-extruded cast polyethylene film envelope having an antifogging property according to one embodiment of the present invention; and

FIG. 2 is a view showing a cucumber wrapped with a co-extruded cast polyethylene film envelope having an antifogging property according to one embodiment of the present invention.

### BEST MODE FOR CARRYING OUT THE INVENTION

Reference will now be made in detail to the preferred embodiments of the present invention.

Hereinafter, a preferred embodiment of the present invention will be described with reference to accompanying drawings.

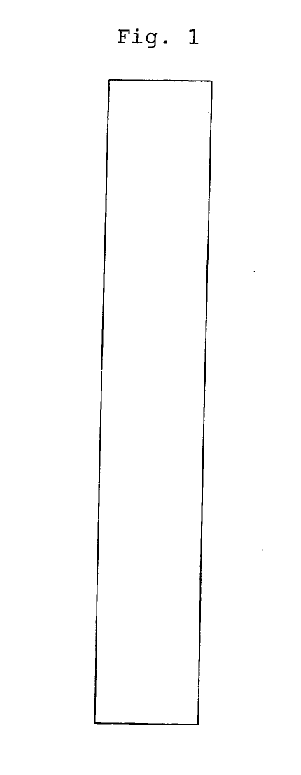

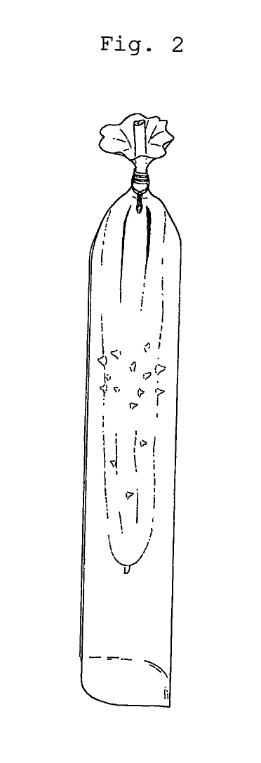

FIG. 1 is a view illustrating a co-extruded cast polyethylene film envelope having an antifogging property according to one embodiment of the present invention, and FIG. 2 is a view showing a cucumber wrapped with the co-extruded cast polyethylene film envelope.

An antifogging cast polypropylene film of the present invention includes polypropylene resin having a melt index of 3 to 10 g/10 min. Copolymer resin used for the present invention is one selected from the group consisting of propylene-ethylene copolymer, propylene-butene copolymer and propylene-ethylene-butene terpolymer. Preferably, the copolymer resin has a melt index of 5 to 12 g/10 min in order to facilitate a flow of resin in an extruder.

In addition, high polymer resins (polypropylene resin and polypropylene copolymer resin) forming the antifogging cast polypropylene film of the present invention include 1 to 20 weight percent of an antifogging surface active agent, which is at least one selected from the group consisting of sorbitan fatty acid ester, glycerin fatty acid ester, and polyglycerin fatty acid ester, so that dew is not formed on an inner surface of the antifogging cast polypropylene film even if a surface temperature of the antifogging cast polypropylene falls lower than a dew point of ambient air. Preferably, sorbitan fatty acid ester, glycerin fatty acid ester, and polyglycerin fatty acid ester are methyl ester or ethyl ester. If the content of the antifogging surface active agent is less than 1 weight percent, the antifogging property of the film becomes reduced. In addition, if the content of the antifogging surface active agent exceeds 20 weight percent, printing and thermal adhesive properties of the film are lowered although the antifogging property of the film can be improved. In this case, the manufacturing cost for the film may rise and the thermal adhesive temperature becomes high.

Preferably, the antifogging cast polypropylene film of the present invention has a thickness of about 0.01 to 0.1 mm, more preferably, 0.07 mm. If the thickness of the film exceeds 0.1 mm, a transparent degree of the film becomes deteriorated, causing a bad influence on the growth of a cucumber. If the thickness of the film is less than 0.01 mm, a film envelope may be easily torn. Preferably, the film envelope of the present invention has a width of about 4 to 6 cm, more preferably, 4.9 cm. In this case, thorns of the cucumber may preferably extrude out of the film envelope. A length of the film envelope is determined depending on a length of the cucumber. Preferably, the film envelope has a length of about 27 to 29 cm.

The film envelope wrapping the cucumber therein is provided at an upper end thereof with a fixing pin so as to prevent the film envelope from being separated from the cucumber. When the cucumber has a length of 10 cm and flowers thereof have gone, the cucumber is wrapped with the film envelope. The installation time for the film envelope can be adjusted depending on the seasons. When wrapping the cucumber with the film envelope, flowers of the cucumber must be removed while preventing immature cucumbers from being damaged. Preferably, the film envelope is applied to the cucumber after 10 days since the initial harvest of the cucumbers. At this time, it is necessary to select cucumbers having superior quality. According to the present invention, less than four cucumbers are wrapped with the film envelope per one week in order to uniformly grow the cucumbers. The cucumber wrapped with the film envelope of the present invention is prevented from closely making contact with the film envelope caused by water collected at a lower portion of the film envelope. Thus, the film envelope is well ventilated.

According to the present invention, in the hot season, the cucumber harvest is carried out once a day in the morning or in the evening in such a manner that the cucumber maintains a low temperature adapted for storing. Farmers can harvest the cucumbers if 5 to 8 days lapse after installing the film envelope. Preferably, farmers harvest the cucumbers if the cucumbers have a length of about 24 to 27 cm. The cucumber harvest is carried out when the film envelope is fully packed with the cucumber without forming dew in the film envelope. After harvesting the cucumbers, abnormal cucumbers, such as cucumbers having club shapes, are separated from the cucumbers in order to improve the commercial value of the cucumbers. In addition, the cucumbers are selectively wrapped according to lengths of the cucumbers.

Hereinafter, various embodiments of the present invention will be described in detail. It is noted that the embodiments described below does not limit the scope of the present invention.

### Embodiment 1

A mixture including 84 weight percent of polypropylene resin having a melt index of 3 to 10 g/min at a temperature of 185° C., 6 weight percent of sorbitan fatty acid ester, 5 weight percent of an antistatic agent and 5 weight percent of white carbon is prepared. Then, the mixture is inputted into an inflation multi-film extruder through a hopper in such a manner that a roll-film having a double-layer sectional structure can be obtained. Then, a fixing pin is provided at an upper end of a film envelope. After that, when the cucumber has a length of about 5 to 10 cm and flowers thereof have gone, the cucumber is wrapped with the film envelope and the film envelope is closed by means of the fixing pin. Then, after 5 to 8 days, cucumbers having lengths of about 24 to 27 cm are harvested.

### Embodiment 2

A mixture including 84 weight percent of polypropylene resin having a melt index of 3 to 10 g/min at a temperature of 185° C., 6 weight percent of glycerin fatty acid ester, 5 weight percent of an antistatic agent and 5 weight percent of white carbon is prepared. Then, the mixture is inputted into an inflation multi-film extruder through a hopper in such a manner that a roll-film having a double-layer sectional structure can be obtained. Then, a fixing pin is provided at an upper end of a film envelope. After that, when the cucumber has a length of about 5 to 10 cm and flowers thereof have gone, the cucumber is wrapped with the film envelope and the film envelope is closed by means of the fixing pin. Then, after 5 to 8 days, cucumbers having lengths of about 24 to 27 cm are harvested.

### Embodiment 3

A mixture including 84 weight percent of polypropylene resin having a melt index of 3 to 10 g/min at a temperature of 185° C., 6 weight percent of polyglycerin fatty acid ester, 5 weight percent of an antistatic agent and 5 weight percent of white carbon is prepared. Then, the mixture is inputted into an inflation multi-film extruder through a hopper in such a manner that a roll-film having a double-layer sectional structure can be obtained. Then, a fixing pin is provided at an upper end of a film envelope. After that, when the cucumber has a length of about 5 to 10 cm and flowers thereof have gone, the cucumber is wrapped with the film envelope and the film envelope is closed by means of the fixing pin. Then, after 5 to 8 days, cucumbers having lengths of about 24 to 27 cm are harvested.

### Embodiment 4

A mixture including 84 weight percent of polypropylene resin having a melt index of 3 to 10 g/min at a temperature of 185° C., 1.0 weight percent of polyglycerin fatty acid ester, 5 weight percent of an antistatic agent and 5 weight percent of white carbon is prepared. Then, the mixture is inputted into an inflation multi-film extruder through a hopper in such a manner that a roll-film having a double-layer sectional structure can be obtained. Then, a fixing pin is provided at an upper end of a film envelope. After that, when the cucumber has a length of about 5 to 10 cm and flowers thereof have gone, the cucumber is wrapped with the film envelope and the film envelope is closed by means of the fixing pin. Then, after 5 to 8 days, cucumbers having lengths of about 24 to 27 cm are harvested.

### Comparative Example 1

A mixture including 89 weight percent of polypropylene resin having a melt index of 3 to 10 g/min at a temperature of 185° C., 1.0 weight percent of polyglycerin fatty acid ester, 5 weight percent of an antistatic agent and 5 weight percent of white carbon is prepared. Then, the mixture is inputted into an inflation multi-film extruder through a hopper in such a manner that a roll-film having a double-layer sectional structure can be obtained. Then, a fixing pin is provided at an upper end of a film envelope. After that, when the cucumber has a length of about 5 to 10 cm and flowers thereof have gone, the cucumber is wrapped with the film envelope and the film envelope is closed by means of the fixing pin. Then, after 5 to 8 days, cucumbers having lengths of about 24 to 27 cm are harvested.

### Comparative Example 2

A mixture including 84 weight percent of polypropylene resin having a melt index of 3 to 10 g/min at a temperature of 185° C., 25.0 weight percent of polyglycerin fatty acid ester, 5 weight percent of an antistatic agent and 5 weight percent of white carbon is prepared. Then, the mixture is inputted into an inflation multi-film extruder through a hopper in such a manner that a roll-film having a double-layer sectional structure can be obtained. Then, a fixing pin is provided at an upper end of a film envelope. After that, when the cucumber has a length of about 5 to 10 cm and flowers thereof have gone, the cucumber is wrapped with the film envelope and the film envelope is closed by means of the fixing pin. Then, after 5 to 8 days, cucumbers having lengths of about 24 to 27 cm are harvested.

### Comparative Example 3

A mixture including 84 weight percent of ethylene-butene copolymer having a melt index of 3 to 10 g/min at a temperature of 185° C., 6.0 weight percent of polyglycerin fatty acid ester, 5 weight percent of an antistatic agent and 5 weight percent of white carbon is prepared. Then, the mixture is inputted into an inflation multi-film extruder through a hopper in such a manner that a roll-film having a double-layer sectional structure can be obtained. Then, a fixing pin is provided at an upper end of a film envelope. After that, when the cucumber has a length of about 5 to 10 cm and flowers thereof have gone, the cucumber is wrapped with the film envelope and the film envelope is closed by means of the fixing pin. Then, after 5 to 8 days, cucumbers having lengths of about 24 to 27 cm are harvested.

### Comparative Example 4

A mixture including 84 weight percent of propylene-ethylene-butene copolymer having a melt index of 3 to 10 g/min at a temperature of 185° C., 6.0 weight percent of polyglycerin fatty acid ester, 5 weight percent of an antistatic agent and 5 weight percent of white carbon is prepared. Then, the mixture is inputted into an inflation multi-film extruder through a hopper in such a manner that a roll-film having a double-layer sectional structure can be obtained. Then, a fixing pin is provided at an upper end of a film envelope. After that, when the cucumber has a length of about 5 to 10 cm and flowers thereof have gone, the cucumber is wrapped with the film envelope and the film envelope is closed by means of the fixing pin. Then, after 5 to 8 days, cucumbers having lengths of about 24 to 27 cm are harvested.

After fabricating films according to the Embodiments 1 to 4 and Comparative examples 1 to 4, an antifogging property, durability of the antifogging property, and a blocking property of the films are measured. Table 1 shows the measurement result. In order to measure the antifogging properties of the films, a predetermined amount of water is inputted into paper cups and the paper cups are sealed with the films. Then, the paper cups are stored in a refrigerator so as to observe a dew condensation phenomenon in the paper cups as a function of time. The blocking properties of the films are measured for two days in an oven having a temperature of about 40° C. while applying load of about 20 Kg.

TABLE 1

| | | Anti- | | | | |
|---|---|---|---|---|---|---|
| | | fogging | | | | |
| | Anti- | property | | | | |
| | fogging | (after | | | Tear | Residual |
| | property | 1-hour | | Bending | proof | agri- |
| | (after | refrig- | Block- | of | prop- | cultural |
| | wrapping) | eration) | ing | cucumber | erty | medicine |
| Embodi- | No dew | No dew | X | Straight | Good | X |
| ment 1 | | | | | | |
| Embodi- | No dew | No dew | X | Straight | Good | X |
| ment 2 | | | | | | |
| Embodi- | No dew | No dew | X | Straight | Good | X |
| ment 3 | | | | | | |
| Embodi- | No dew | No dew | X | Straight | Good | X |
| ment 4 | | | | | | |
| Compar- | No dew | No dew | X | Bending | Bad | X |
| ative | | | | | | |
| example 1 | | | | | | |
| Compar- | No dew | No dew | X | Bending | Bad | X |
| ative | | | | | | |
| example 2 | | | | | | |
| Compar- | No dew | No dew | X | Bending | Bad | X |
| ative | | | | | | |
| example 3 | | | | | | |
| Compar- | No dew | No dew | X | Bending | Bad | X |
| ative | | | | | | |
| example 4 | | | | | | |

### Embodiment 5

Embodiment 5 is substantially identical to Embodiments 1 to 4, except that polyethylene resin is used in this embodiment instead of polypropylene resin used in Embodiments 1 to 4. The result of this embodiment is identical to the result of Embodiments 1 to 4.

### Embodiment 6

Embodiment 6 is substantially identical to Embodiments 1 to 4, except that polypropylene copolymer resin is used in this embodiment instead of polypropylene resin used in Embodiments 1 to 4. The result of this embodiment is identical to the result of Embodiments 1 to 4.

### Embodiment 7

Embodiment 7 is substantially identical to Embodiments 1 to 4, except that polyvinyl chloride resin is used in this embodiment instead of polypropylene resin used in Embodiments 1 to 4. The result of this embodiment is identical to the result of Embodiments 1 to 4.

### Embodiment 8

Embodiment 8 is substantially identical to Embodiments 1 to 4, except that ethylene-acetic acid vinyl copolymer resin is used in this embodiment instead of polypropylene resin used in Embodiments 1 to 4. The result of this embodiment is identical to the result of Embodiments 1 to 4.

As is understood from the measurement results of films according to the above embodiments and comparative examples, the film including the antifogging surface active agent does not represent the dew condensation phenomenon after it has been stored in the refrigerator for a predetermined period of time. In addition, the film of the present invention represents the antifogging property for a long period of time. However, if the surface active agent is excessively or insufficiently added to the film, the film represents an inferior antifogging property.

The film envelope for the cucumber of the present invention has a transparent property and allows waterdrops to flow downwards if waterdrops are formed in the film envelope, so that the cucumber contained in the film envelope maintains a high degree of freshness. The cucumber wrapped with the film envelope can be easily cut into two pieces because the film envelope can be easily cut into two pieces. Thus, the antifogging film of the present invention can be effectively used for wrapping the cucumber. In addition, according to the present invention, an immature cucumber is wrapped with the film envelope and grown in the film envelope, so the cucumber cannot be contaminated with agricultural medicines. Thus, it is possible to produce clean cucumbers. In addition, consumers can check the status of the cucumber wrapped with the film envelope of the present invention so that the consumers can reliably purchase the clean cucumber at a store.

The film envelope according to the present invention can prevent the dew condensation phenomenon and has a superior thermal adhesive property at a low temperature. Accordingly, waterdrops are not formed at the inner surface of the film envelope so that the cucumber contained in the film envelope maintains a high degree of freshness. In addition, since waterdrops are not fallen onto the cucumber, it is possible to prevent the cucumber from being rotten. Since the film envelope has the superior thermal adhesive property at the low temperature, life span of a wrapping machine can be expanded.

The antifogging film is fabricated by adding an antifogging agent to a polypropylene film and processing the polypropylene film at a high temperature condition in such a manner that a thin layer is formed on the polypropylene film. The antifogging film can prevent waterdrops from being formed at a surface of the antifogging film after vegetables or fruits are wrapped with the antifogging film. In addition, since the thin layer is formed on the surface of the antifogging film, vegetables or fruits contained in the antifogging film envelope maintains a high degree of freshness. In addition, since the antifogging film is transparent, consumers or farmers can check the status or freshness of props contained in the antifogging film envelope and an external appearance of the antifogging film envelope is improved. According to the present invention, the cucumber contained in the antifogging film envelope can be maintained with high freshness while preventing the cucumber from being damaged or rotten due to water or waterdrops created in the antifogging film envelope.

Generally, the cucumber is slightly bent while the cucumber is being grown. However, the commercial value and marketability of the cucumber may increase if the cucumber has a straight shape with uniform thickness and length. Accordingly, the present invention is provided to grow the cucumber such that the cucumber has a straight shape with uniform thickness and length. That is, it is possible to obtain the cucumber having a length of 27 cm with a uniform thickness by using the film envelope of the present invention. In addition, according to the present invention, farmers may easily recognize the harvest time for the cucumbers because a body of the film envelope is automatically opened if the cucumbers are fully grown in the film envelope, so that farmers can easily harvest the cucumbers. In addition, since the cucumber is grown in the transparent film envelope, it is possible to protect the cucumber from damages by blight and harmful insects and agricultural medicines. When the cucumbers are fully grown, the cucumber are harvested together with the film envelope wrapping the cucumbers and are sold in markets in a state in which the cucumber is contained in the film envelope. Thus, the consumers can recognize that the cucumbers sold in the markets are clean cucumbers. In addition, consumers may know manufacturers of the cucumbers if the manufacturer names are printed on the film envelope, so the consumers can buy the cucumbers with high reliability. Currently, agricultural products have been standardized in the same manner as the industrial products. Such standardization and gradation for the agricultural products may closely relate to the commercial values of the agricultural products. The film envelope of the present invention is adaptable not only for the cucumbers, but also for pears, grapes, watermelons, strawberries, oranges, bananas, eggplants, red peppers, and pumpkins.

### INDUSTRIAL APPLICABILITY

As can be seen from the foregoing, according to the present invention, a film envelope is fabricated by using transparent synthetic resin in order to wrap clean agricultural products including cucumbers. The film envelope is formed at an inner portion thereof with a cavity section for allowing the agricultural products to be grown in the film envelope without applying agricultural medicines to the agricultural products. Accordingly, the film envelope of the present invention may provide advantages to both of consumers and manufactures. If the agricultural products including cucumbers are grown in the film envelope, it is possible to obtain the agricultural products with uniform thickness, standardized size, high commercial value and uniform length, so the film envelope may be useful in farm work.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A synthetic resin film envelope for clean agricultural products, the synthetic resin film envelope comprising:
60 to 90 weight percent of synthetic resin having a melt index of 3 to 10 g/min at a temperature of 185° C.;
1 to 20 weight percent of an antifogging agent;
1 to 10 weight percent of an antistatic agent; and
1 to 10 weight percent of white carbon, wherein the synthetic resin envelope has a thickness of about 0.01 to 0.1 mm with a double-layer sectional structure.

2. The synthetic resin film envelope as claimed in claim 1, wherein the synthetic resin includes at least one selected from the group consisting of polyethylene resin, polypropylene resin, polypropylene copolymer resin, polyvinyl chloride resin, and ethylene-acetic acid vinyl copolymer resin.

3. The synthetic resin film envelope as claimed in claim 1, wherein the clean agricultural products include cucumbers, pears, grapes, watermelons, strawberries, oranges, bananas, eggplants, red peppers, and pumpkins.

4. The synthetic resin film envelope as claimed in claim 1, wherein the antifogging agent includes at least one selected from the group consisting of sorbitan fatty acid ester, glycerin fatty acid ester, and polyglycerin fatty acid ester.

5. The synthetic resin film envelope as claimed in claim 1, wherein the clean agricultural products include cucumbers, and the synthetic resin film envelope is formed with a double-layer sectional structure having a width of about 4 to 6 cm and a length of about 27 to 29 cm.

6. The synthetic resin film envelope as claimed in claim 1, wherein the clean agricultural products include cucumbers, and the synthetic resin film envelope is formed with a double-layer sectional structure having a thickness of about 0.07 mm, a width of about 4 to 6 cm and a length of about 27 to 29 cm.

7. A method of fabricating a synthetic resin film envelope for clean agricultural products, the method comprising the steps of:
i) preparing a mixture including 60 to 90 weight percent of synthetic resin having a melt index of 3 to 10 g/min at a temperature of 185° C., 1 to 20 weight percent of an antifogging agent, 1 to 10 weight percent of an antistatic agent, and 1 to 10 weight percent of white carbon;
ii) inputting the mixture into an inflation film extruder through a hopper so as to obtain a roll-film having a double-layer sectional structure with a thickness of about 0.01 to 0.1 mm.

8. The method as claimed in claim 7, wherein the clean agricultural products include cucumbers, and the synthetic resin film envelope is formed with a double-layer sectional structure having a thickness of about 0.07 mm, a width of about 4 to 6 cm and a length of about 27 to 29 cm.

9. A method of growing clean agricultural products, the method comprising the steps of:
i) preparing a synthetic resin film envelope including 60 to 90 weight percent of polypropylene resin having a melt index of 3 to 10 g/min at a temperature of 185° C., 1 to 20 weight percent of an antifogging agent, 1 to 10 weight percent of an antistatic agent, and 1 to 10 weight percent of white carbon;
ii) installing a fixing pin at an upper end of the synthetic resin film envelope;
iii) wrapping immature clean agricultural products with the synthetic resin film envelope when the immature clean agricultural products have lengths of about 5 to 10 cmm and flowers thereof have gone; and
iv) harvesting clean agricultural products after a predetermined period of time lapses after wrapping immature clean agricultural products with the synthetic resin film envelope.

10. A method of growing clean cucumbers, the method comprising the steps of:
i) preparing a synthetic resin film envelope having a thickness of about 0.01 to 0.1 mm, a width of about 4 to 6 cm, and a length of about 27 to 29 cm, and including 60 to 90 weight percent of polypropylene resin having a melt index of 3 to 10 g/min at a temperature of 185° C., 1 to 20 weight percent of an antifogging agent, 1 to 10 weight percent of an antistatic agent, and 1 to 10 weight percent of white carbon;
ii) installing a fixing pin at an upper end of the synthetic resin film envelope;
iii) wrapping immature clean cucumbers with the synthetic resin film envelope when the immature cucumbers have lengths of about 5 to 10 cmm and flowers thereof have gone; and
iv) harvesting clean cucumbers having lengths of about 24 to 27 cm when 5 to 8 days lapse after wrapping the immature clean cucumbers with the synthetic resin film envelope.

11. The method as claimed in claim 10, wherein the synthetic resin film envelope is formed with a double-layer sectional structure having a thickness of about 0.07 mm, a width of about 4.9 cm, and a length of about 29, and includes 84 weight percent of polypropylene resin having a melt index of 3 to 10 g/min at a temperature of 185° C., 6 weight percent of sorbitan fatty acid ester, 5 weight percent of an antistatic agent, and 5 weight percent of white carbon.
